(19) United States
(12) Patent Application Publication
(10) Pub. No.: US 2021/0407070 A1
(43) Pub. Date: Dec. 30, 2021

(54) METHODS AND SYSTEMS FOR NON-DESTRUCTIVE TESTING (NDT) WITH TRAINED ARTIFICIAL INTELLIGENCE BASED PROCESSING

(71) Applicant: ILLINOIS TOOL WORKS INC., Glenview, IL (US)

(72) Inventors: Andrew Swantek, Park Ridge, IL (US); Wyatt Burns, Woodridge, IL (US); David Fry, Evanston, IL (US); Raymond Berry, Glenview, IL (US)

(21) Appl. No.: 17/350,536

(22) Filed: Jun. 17, 2021

Related U.S. Application Data
(60) Provisional application No. 63/044,476, filed on Jun. 26, 2020.

(51) Int. Cl. G06T 7/00; G06T 7/90; G06N 3/08; G06N 3/04

(52) U.S. Cl. CPC G06T 7/0002; G06N 3/0445; G06N 3/08; G06T 7/90

(57) ABSTRACT

Systems and methods are provided for non-destructive testing (NDT) with trained artificial intelligence based processing.

### CLAIM OF PRIORITY

This patent application makes reference to, claims priority to and claims benefit from U.S. Provisional Patent Application Ser. No. 63/044,476, filed on Jun. 26, 2020. The above identified application is hereby incorporated herein by reference in its entirety.

### BACKGROUND

Non-destructive testing (NDT) is used to evaluate properties and/or characteristics of material, components, and/or systems without causing damage or altering the tested item. Because non-destructive testing does not permanently alter the article being inspected, it is a highly valuable technique, allowing for savings in cost and/or time when used for product evaluation, troubleshooting, and research. Frequently used non-destructive testing methods include magnetic-particle inspections, eddy-current testing, liquid (or dye) penetrant inspection, radiographic inspection, ultrasonic testing, and visual testing. Non-destructive testing (NDT) is commonly used in such fields as mechanical engineering, petroleum engineering, electrical engineering, systems engineering, aeronautical engineering, medicine, art, and the like.

Limitations and disadvantages of conventional approaches will become apparent to one management of skill in the art, through comparison of such approaches with some aspects of methods and systems set forth in the remainder of this disclosure with reference to the drawings.

### BRIEF SUMMARY

Aspects of the present disclosure relate to product testing and inspection. More specifically, various implementations in accordance with the present disclosure are directed to methods and systems for non-destructive testing (NDT) with trained artificial intelligence based processing, substantially as illustrated by or described in connection with at least one of the figures, and as set forth more completely in the claims.

These and other advantages, aspects and novel features of the present disclosure, as well as details of an illustrated implementation thereof, will be more fully understood from the following description and drawings.

### BRIEF DESCRIPTION OF THE DRAWINGS

FIG. 1 illustrates an example visual-based non-destructive testing (NDT) inspection setup.

FIG. 2 illustrates an example visual-based non-destructive testing (NDT) inspection setup with trained artificial intelligence based processing, in accordance with the present disclosure.

### DETAILED DESCRIPTION

Various implementations in accordance with the present disclosure are directed to providing enhanced and optimized non-destructive testing (NDT) inspections, particularly by implementing and operating non-destructive testing (NDT) based setups with trained artificial intelligence based processing.

In this regard, as noted above, non-destructive testing (NDT) is used to evaluate properties and/or characteristics of material, components, and/or systems without causing damage or altering the tested item. In some instances, dedicated material and/or products may be required for and/or used when conducting non-destructive testing. For example, non-destructive testing of particular type of articles may entail applying (e.g., by spraying on, pouring into, passing through, etc.), to the would-be tested article or part material configured for facilitating performing the non-destructive testing. Such material (referred to hereinafter as “NDT material”) may have and/or exhibit certain characteristics (e.g., magnetic, visual, etc.) suitable for the non-destructive testing—e.g., characteristics that would allow for, or enhance detection of defects, irregularities, and/or imperfections (referred to collectively hereinafter as “anomalies”) in the inspected article during the non-destructive testing (NDT).

Non-destructive testing (NDT) may be conducted in different manner—with respect to the way by which anomalies may be detected. For example, in some instances, the NDT based inspections are conducted visually—that is, where the detection of anomalies is done by visually inspecting the inspected articles. Such visual-based NDT may be possible (or enhanced) by use of suitable NDT material. For example, application of such NDT material may make any anomalies in the inspected articles more easily detected, particularly based on certain characteristics of NDT material. The anomalies may be visually identified based on, e.g., color contrast or some light-related behavior.

In some instances, ambient light may be used in such visual inspections—that is, the users may simply visually inspect the article in a well-lit area, such as after application of the NDT material. Alternatively or additionally, a light source (e.g., a special lamp) may be used within the system or setup being used to conduct the NDT inspection. In this regard, such light source may provide light that meets particular criteria for conducting the inspections.

Non-destructive testing (NDT) may pose some challenge and/or may have some limitations, however. For example, in some instances NDT may entail complex processing when assessing inspected article, such as to make a determination (particularly initially) whether anomalies may be present. This may be particularly the case with inspection solutions based on capturing and processing of visual data (e.g., images).

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

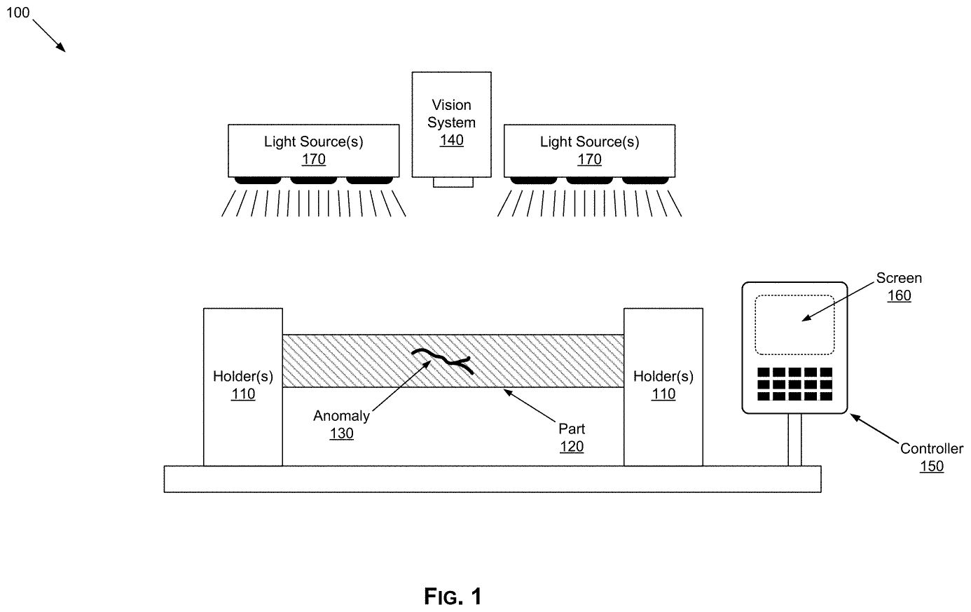

FIG. 1 illustrates an example visual-based non-destructive testing (NDT) inspection setup. Shown in FIG. 1 is a non-destructive testing (NDT) setup 100 which may be used in performing visual-based NDT inspections.

The NDT setup 100 may comprise various components configured for non-destructive testing (NDT) inspection of articles (e.g., machine parts and the like), in accordance with particular NDT inspection methodology and/or techniques. Specifically, the NDT setup 100 may be configured for visual-based NDT inspections. In this regard, in visual-based NDT inspections, anomalies in inspected articles may be detected visually—that is, by visual examination of the article. Accordingly, visual-based NDT inspections may entail use of specific lighting conditions.

In this regard, while some visual-based NDT inspections may be performed using visible (e.g., white) wavelengths, in some instances other wavelengths (e.g., ultraviolet (UV), X-ray, etc.) may be used. Thus, in some instances, visual-based NDT inspections may be performed using ambient light. However, in other instances, dedicated light or radiation sources may be used in the inspection setup, being configured to project light on the inspected articles. For example, specially designed light sources (e.g., lamps or the like) may be incorporated into the inspection setups, being configured to emit light in particular manner. The emitted light may be visible (e.g., white) light, light and/or radiation of other wavelengths (e.g., ultraviolet (UV) light, X-ray radiation), or any combination thereof.

In some instances, visual-based NDT inspections may entail use of NDT material, which is applied to the to-be-inspected articles. In this regard, anomalies may be visually identified based on, for example, color contrast or another light-related behavior, which may be caused or enhanced by the applied NDT material.

Various visual-based NDT inspections techniques are used. The two main techniques are “magnetic particle inspection” (MPI) technique and the “liquid penetrant inspection” (LPI) technique, with the MPI technique typically being used with ferrous material, and the LPI technique typically being used with non-ferrous material (e.g., aluminum, brass, etc.). With either technique, the goal is to make anomalies visible when the article is visually examined (e.g., under the light source). Accordingly, in various implementations the NDT setup 100 may be configured for performing MPI based inspections and/or LPI based inspections.

As shown in the example implementation illustrated in FIG. 1, the NDT setup 100 comprises holders 120 which may be configured for holding a particular article 110 (e.g., a machine part) during NDT inspections using the NDT setup 100. In this regard, the article 110 may be placed in particular manner—e.g., being secured in a particular position using holders 120, so that it may be inspected in accordance with particular technique. For example, while not shown in FIG. 1, the NDT setup 100 may be configured for magnetic particle inspection (MPI), such as using bathing technique (e.g., the NDT setup 100 being a wet bench-based setup), or for liquid penetrant inspection (LPI).

The NDT setup 100 also comprises a vision system 140, which may be used to assist the user when conducting visual-based NDT inspections, such as when inspecting the particular article 110 (e.g., a machine part). The vision system 140 may comprise suitable hardware (including circuitry) for obtaining a visual scan of the article being inspected during the inspection, and for generating corresponding scanning data. In this regard, the vision system 140 may comprise dedicated vision equipment configured for enhanced detection of anomalies—e.g., assisting the user in correctly identifying anomalies in inspected articles, (optionally) taking or triggering additional actions for ensuring enhanced detection, such as providing related feedback to the user, taking autonomous corrective measures, etc.

In an example implementation, the vision system 140 comprises a camera that is configured to obtain still pictures or video of the inspected article during the inspection, and as such the scanning data may comprise pictorial or video data. Once obtained, the scanning data may be processed, such as to obtain information pertinent to identification of an anomaly of interest, and/or for enhancing reliability and performance of visual inspection. In this regard, as explained above, conventional approaches for performing visual inspections in NDT setups may suffer from reliability and accuracy related issues, particularly with respect to missed anomalies and/or false negatives. This may be due to issues relating with lighting conditions, issues with the setup, operator errors (e.g., due to lack of familiarity with particular articles and/or expected behavior corresponding to anomalies).

The vision system 140 may be a fixed component. In this regard, the vision system 140 may be permanently fixed (e.g., attached to one of the other components) in the NDT setup 100, such as above an inspection surface or over the holders 120. In other implementations, however, the vision system 140 may be moveable and/or adjustable, to enable temporary placement and/or adjustment of position thereof within the NDT setup 100.

For example, the vision system 140 may comprise an attachment element (e.g., clip-like component) to enable its attachment to certain points in the NDT setup 100. This may allow the user some flexibility in determining where and how to place and/or position the vision system 140 within the NDT setup 100, such as based on the user preferences (e.g., to ensure that the sensor would not interfere with the inspection), to optimize inspection (e.g., based on the article being inspected, inspection parameters, etc.), and the like.

The NDT setup 100 may also comprise light source(s) 170, which may be configured for emitting and/or projecting light onto articles being inspected. The light source(s) 170 may be configured for generating and emitting light of particular type, with particular characteristics, and/or in particular manner. For example, the light source(s) 170 may be configured for emitting white and/or ultraviolet (UV) light, and projecting the emitted light mostly downwards onto the holding structure used to secure the inspect part 110.

Further, while not shown in FIG. 1, in some instances an inspection enclosure may be used, to enhance performance (e.g., improve ability to detect anomalies), such as when using dedicated light sources (e.g., the light source(s) 170 in the NDT setup 100). In this regard, the inspection enclosure may be used to provide a suitable and/or consistent lighting environment for the inspection, such as by blocking or otherwise limiting ambient light. This may be done to control the lighting conditions—e.g., by blocking ambient lights, thus ensuring that most of the light within the NDT setup 100 is that originating from light sources used therein, thus allowing controlled lighting environment for the inspections. Such inspection enclosure may be, for example, a tent-like structure or any other structure that provides sufficient shading. Further, the inspection enclosure may be adjustable—e.g., based on the user's preferences, surrounding space, etc.

The NDT setup 100 may also comprise a controller unit 150 configured for controlling the NDT setup 100 and various components thereof, particularly to facilitate conducting NDT inspections using the setup. For example, the controller unit 150 may comprise suitable circuitry for processing of data related to conducting the inspection (e.g., pre-stored data, data obtained during the inspections, etc.), and/or for performing and/or controlling various actions during the inspections (e.g., based on processing of the data). The controller 160 may also incorporate input and/or output components, such as a keypad (or the like), a screen or display 160, etc. In this regard, the display 160 may be used to display information related to the inspections, including information determined while conducting the inspection (such as based on processing of obtained sensory data). For example, the display 160 may be used to display information relating to any detected indications and/or corresponding identified anomalies (e.g., alerts and/or feedback data as described above). The disclosure is not so limited, however, and as such other combination or variations may be supported. For example, the “controller” may comprise an already included controller circuitry (e.g., controller circuitry for the light sources(s) 170), which may be configured to performed some the required processing functions. Further, in some instances, at least some of the processing may be performed within at least one of the vision system 140.

For example, the processing of the scanning data may be configured to enable identifying particular indications of possible anomalies (e.g., anomaly 130 as shown in FIG. 1) in the inspected article, such as based on particular identification criteria. In this regard, each indication may correspond to an area on the inspected article exhibiting particular characteristics (e.g., particular color or variation thereof) that may be indicative of an anomaly or indication in that area. The identified indications may then be assessed, to determine whether they correspond to actual anomalies (or to anomalies that are unacceptable). In this regard, each indication may be assessed based on acceptance criteria associated with the particular article being inspected. The acceptance criteria may define, for example, when each anomaly is acceptable or not, such as by defining applicable thresholds for what constitute anomalies based on which the article may be rejected (or otherwise deemed unacceptable). In this regard, different identification criteria and/or the acceptance criteria may be defined, such as for different articles (e.g., different types of articles, different parts, different products, etc.) and/or for different operators (e.g., different preferences). Further, the identification criteria may be user-defined, system-defined, Al-defined, default, or some combination.

Visual inspections may have some challenges, however. For example, handling the detection of anomalies by the system (e.g., the vision system 140 and the controller unit 150) may require a lot of complexity (and resources) to ensure accurate detection of all anomalies. This may be even more pressing (and resulting in even more complexity and requiring more time) if the system completely handled the detection of anomalies. Accordingly, it may be desirable to reduce complexity of the system (and operations performed thereby) to optimize detection of anomalies, but without affecting the accuracy or reliability of such detection

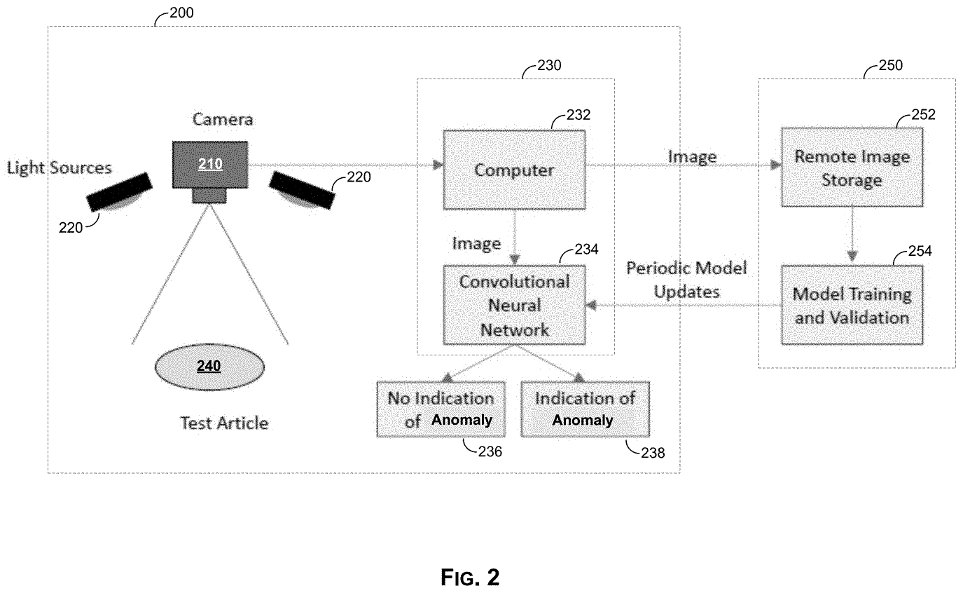

In implementations in accordance with the present disclosure, this may be done by use of artificial intelligence based techniques, particularly in a manner that greatly reduce complexity of the processing required during detection of anomalies while maintaining (and even enhancing) accuracy of the detection during inspection. A particular example implementation is described with respect to FIG. 2.

FIG. 2 illustrates an example visual-based non-destructive testing (NDT) inspection setup with trained artificial intelligence based processing, in accordance with the present disclosure. Shown in FIG. 2 is a non-destructive testing (NDT) setup 200 which may be used in performing visual-based NDT inspections.

The NDT setup 200 may be substantially similar to the NDT setup 100 of FIG. 1, thus similarly comprising a visual system 210 (e.g., a camera) configured for supporting visual inspection of articles (e.g., a machine part), such as test article 240, which may be placed in particular manner—e.g., secured in a particular position, such as using support/holding structure (not shown), so that it may be inspected in accordance with particular inspection technique (e.g., based on magnetic particle inspection (MPI) technique or liquid penetrant inspection (LPI)). Further, light sources 220 may be used to provide lighting during the inspection, particularly where certain lighting conditions (e.g., particular type, intensity, etc.) may be needed.

Sensory visual data (e.g., images) obtained via the visual system 210 may be processed, for identification of any possible anomalies in the test article 240. This may be done via a local control unit 230, which may be substantially similar to the control unit 150 of FIG. 1. For example, the control unit 230 may comprise a computer 232 which may be configured to receive images captured via the camera 210, and to process the images, such as to make a determination whether or not anomalies may be present in the test article 240. The computer 232 may be configured to generate feedback based on the determination (e.g., indication of no anomaly 236 or indication of anomaly 238). In this regard, the generated feedback may serve as an initial assessment, with the operator conducting the inspection then performing more detailed and careful examination of the test article 240 (e.g., when indication of anomaly 238 is generated). The generated indications may be visual, audible, or the like. For example, as with the NDT setup 100 of FIG. 1, the NDT setup 200 may also incorporate a display or screen (not shown) which may be used to provide the indication of no anomaly 236 and the indication of anomaly 238 visually.

In accordance with the present disclosure, learning techniques may be used to enhance and/or optimize performance during inspections, particularly with respect to imaging related processing. For example, the control unit 230 (and/or components thereof, such as the computer 232) may be configured to implement and/or use deep learning techniques and/or algorithms, such as by use of deep neural networks (e.g., a convolutional neural network (CNN) 234 as shown in FIG. 2), and/or may utilize any suitable form of artificial intelligence image analysis techniques or machine learning processing functionality, which may be configured to analyze captured images, such as to identify possible anomalies in inspected test articles. In some instances, deep neural networks (e.g., the CNN 234) used in the NDT setup 200 may utilize models during analysis of images, to help identify possible anomalies. In this regard, these model may define or describe particular characteristics that correspond to certain anomalies (or types thereof) that may be present in inspected test articles.

In accordance with the present disclosure, training of the models used in conjunction with artificial intelligence based image analysis (that is generating of the models and/or subsequent revisions thereof) may be performed in remote, centralized systems (e.g., remote system 250 illustrated in FIG. 2). The remote system 250 may comprise suitable circuitry—e.g., communication circuitry (e.g., for facilitating communication operations, such as for communicating with NDT setups, via Internet connections, e.g., using suitable communication media, interfaces, and/or networks), processing circuitry (e.g., for performing necessary processing functions, such as processing of images, generating and updating models, etc.), storage circuitry (e.g., for performing storage functions), and the like.

The remote system 250 may be configured for receiving images captured at NDT setups, and storing these images (e.g., in a remote image storage module 252 implemented therein). In this regard, the remote image storage module 252 may be configured for storing images (e.g., based on source), and/or for maintaining databases generated based thereon. Further, the remote system 250 may be configured for generating and updating models (e.g., via model training and validation module 254 implemented therein). In this regard, the model training and validation module 254 may comprise suitable circuitry configured for training models used in deep learning (e.g., models for deep neural networks, such as convolutional neural network (CNN) (e.g., the CNN 234 in the NDT setup 200).

The models may be trained to, for example, identify particular structures, features, and/or characteristics associated with particular anomalies (or types thereof), particularly for certain test articles (or types thereof), which may be identified during processing of images of the test articles. The models may be provided to NDT setups (e.g., NDT setup 200) and used therein to pre-trained deep learning components (e.g., the CNN 234) for use when conducting visual inspections.

In an example use scenario, the camera 210 captures an image of the test article 240, which has undergone all steps of a magnetic particle or liquid penetrant application process that precede inspection. The captured image is transmitted to the computer 232, which passes the image through the pre-trained convolutional neural network (CNN) 234. The CNN 234 may then generate an indication that is provided to an operator, notifying the operator if the indication of an anomaly has appeared, with a trained operator (same or another) performing a subsequent more careful inspection, if there was an indication of anomaly 238.

The image is also transmitted to the remote system 250, for storage in the remote image storage 252. The remote image storage 252 retains the image (e.g., for traceability). Images stored in the remote image storage 252 may then be used to re-train the CNNs, as additional images are acquired, further increasing the accuracy of the model, and reducing false positives and false negatives. In this regard, periodic model updates may be sent to NDT setups (e.g., the NDT setup 200) to continually (re-)train CNN used therein.

Thus, implementations in accordance with the present disclosure allow for use of a convolutional Neural network (either custom or build with transfer learnings) to provide indication of anomalies during NDT inspections (e.g., MPI or LPI NDT inspection). Further, in some implementations, the CNN used during the NDT inspection may comprise a section which performs convolutional operations for feature extraction. The CNN may also comprise a section that is fully connected and performs classification. The present disclosure and implementations based thereon also allow for, and incorporate the ability to generate and maintain image databases, and to subsequently use such databases for models (re-)training and/or for updating the algorithms implemented and used during the artificial intelligence based image analysis.

Solutions in accordance with the present disclosure have various advantages over conventional solutions (if any existence). For example, in accordance with the present disclosure processing images captured during inspections, using artificial intelligence implementation (e.g., via deep learning neural networks), does not entail or require use of reference images, as may be the case with conventional solutions. Further, in accordance with the present disclosure, processing images captured during inspections, does not entail or require performing various imaging enhancement processing functions (e.g., grayscale balance, edge detection, etc.), as may be the case with conventional solutions. In addition, implementations in accordance with the present disclosure do not require use of classification algorithms, as may be the case with conventional solutions. This may be advantageous as classification algorithms may require the developer to select input features for the algorithm—e.g., geometric properties, intensity properties, etc., such as to detect or identify an anomaly when inspecting.

In this regard, the use of neural networks (e.g., CNNs) in accordance with the present disclosure allows for enhanced performance, and for doing so in optimal manner (e.g., with less complexity, less costs, etc.). For example, as described above, use of neural networks (e.g., the CNN 234) in accordance with the present disclosure necessitates only use of a single image (no reference image), eliminates the need for an algorithm developer to prescribe what features are important (as important features are automatically determined in convolutional layers. Further, use of neural networks (e.g., the CNN 234) in accordance with the present disclosure has lower susceptibility to image noise, and is more robust in many applications (e.g., no requiring re-training for different products and/or shapes; rather, it would work with multiple ones).

Use of neural networks (e.g., the CNN 234) in accordance with the present disclosure also reduces the need for image processing, which increases speed of processing (and thus reduce inspection time). In addition, use of neural networks (e.g., the CNN 234) in accordance with the present disclosure reduces need for optical filters (e.g., on the camera 210), and reduces the need for operator to inspect by eye (e.g., eliminating the initial/baseline visual inspection stage). Also, use of neural networks (e.g., the CNN 234) in accordance with the present disclosure may yield faster execution is fast, and may allow for enhanced tuning to balance false positive, false negative, and accuracy (e.g., by use of threshold(s), to determine when something is classified as likely anomaly). The use of neural networks (e.g., the CNN 234) in accordance with the present disclosure may also obviate the need to use of very complex and specially designed vision/scanning system (e.g., cameras), thus allowing for use of off-the-shelf vision/scanning systems (e.g., cameras), which reduces costs.

Another advantage that solutions in accordance with the present disclosure offer is collection of captured images (and, optionally, from multiple setups), particularly in centralized location (e.g., the remote system 250), and the generation of database of images based thereon. This enables and facilitates model (re-)training and updating (and particularly in more accurate and economic manner, as it is done in centralized location/server, where all complex processing needed for (re-)training needs to be concentrated, and where images from different setups may be maintained), thus increase accuracy metrics and/or traceability.

An example system for use in non-destructive testing (NDT), in accordance with the present disclosure, may comprise a scanner configured to obtain a scan of an article during non-destructive testing (NDT) inspection of the article, and one or more circuits that are configured to identify based on the obtained scan of the article, possible anomalies in the article, and generate inspection related feedback relating to the article, wherein the inspection related feedback comprises an indication of anomaly corresponding to each identified possible anomaly. The identifying of possible anomalies comprises applying an adaptive learning algorithm based analysis to the obtained scan of the article, and the adaptive learning algorithm based analysis is configured for application without use of reference scans.

In an example implementation, the adaptive learning algorithm based analysis comprises use of convolutional neural network (CNN), and wherein the one or more circuits are configured to implement the convolutional neural network (CNN).

In an example implementation, the one or more circuits are configured to apply the adaptive learning algorithm based analysis without performing scan enhancement processing.

In an example implementation, the one or more circuits are configured to transmit the obtained scan to a remote system, and wherein the remote system is configured for generating information for implementing and/or adjusting the adaptive learning algorithm based analysis.

In an example implementation, the one or more circuits are configured to obtain from a remote system, control information for one or both of implementing and adjusting the adaptive learning algorithm based analysis.

In an example implementation, the one or more circuits are configured to periodically obtain the control information from the remote system.

In an example implementation, the scanner comprises a visual scanning device, and wherein the scan comprises a visual scan.

In an example implementation, the visual scanning device comprises a camera, and wherein the visual scan comprises an image of the article.

In an example implementation, the system further comprises a feedback component configured to provide inspection related feedback to an operator of the system during the non-destructive testing (NDT) inspection.

In an example implementation, the feedback component comprises a visual output device.

In an example implementation, the feedback component comprises an audible output device.

In an example implementation, the system is configured for performing liquid penetrant inspection (LPI).

In an example implementation, the system is configured for performing magnetic particle inspection (MPI).

Other implementations in accordance with the present disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various implementations in accordance with the present disclosure may be realized in hardware, software, or a combination of hardware and software. The present disclosure may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various implementations in accordance with the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain implementations, it will be understood by those skilled in the art that various changes may be made and equivalents may be substituted without departing from the scope of the present disclosure. For example, block and/or components of disclosed examples may be combined, divided, re-arranged, and/or otherwise modified. In addition, many modifications may be made to adapt a particular situation or material to the teachings of the present disclosure without departing from its scope. Therefore, it is intended that the present disclosure not be limited to the particular implementation disclosed, but that the present disclosure will include all implementations falling within the scope of the appended claims.

What is claimed is:

1. A system for use in non-destructive testing (NDT), the system comprising:
a scanner configured to obtain a scan of an article during non-destructive testing (NDT) inspection of the article; and
one or more circuits configured to:
identify based on the obtained scan of the article, possible anomalies in the article; and
generate inspection related feedback relating to the article, wherein the inspection related feedback comprises an indication of anomaly corresponding to each identified possible anomaly;
wherein:
the identifying of possible anomalies comprises applying an adaptive learning algorithm based analysis to the obtained scan of the article; and
the adaptive learning algorithm based analysis is configured for application without use of reference scans.

2. The system of claim 1, wherein the adaptive learning algorithm based analysis comprises use of convolutional neural network (CNN), and wherein the one or more circuits are configured to implement the convolutional neural network (CNN).

3. The system of claim 1, wherein the one or more circuits are configured to apply the adaptive learning algorithm based analysis without performing scan enhancement processing.

4. The system of claim 1, wherein the one or more circuits are configured to transmit the obtained scan to a remote system, and wherein the remote system is configured for generating information for implementing and/or adjusting the adaptive learning algorithm based analysis.

5. The system of claim 1, wherein the one or more circuits are configured to obtain from a remote system, control information for one or both of implementing and adjusting the adaptive learning algorithm based analysis.

6. The system of claim 5, wherein the one or more circuits are configured to periodically obtain the control information from the remote system.

7. The system of claim 1, wherein the scanner comprises a visual scanning device, and wherein the scan comprises a visual scan.

8. The system of claim 7, wherein the visual scanning device comprises a camera, and wherein the visual scan comprises an image of the article.

9. The system of claim 1, comprising a feedback component configured to provide inspection related feedback to an operator of the system during the non-destructive testing (NDT) inspection.

10. The system of claim 9, wherein the feedback component comprises a visual output device.

11. The system of claim 9, wherein the feedback component comprises an audible output device.

12. The system of claim 1, wherein the system is configured for performing liquid penetrant inspection (LPI).

13. The system of claim 1, wherein the system is configured for performing magnetic particle inspection (MPI).
